(19) United States
(12) Patent Application Publication
(10) Pub. No.: US 2026/0140052 A1
(43) Pub. Date: May 21, 2026

(54) QUANTITATIVE DETECTION METHOD FOR ADULTERATION IN ANGELICA SINENSIS BASED ON TERAHERTZ SPECTROSCOPY AND DATA FUSION

(71) Applicant: EAST CHINA JIAOTONG UNIVERSITY, NANCHANG (CN)

(72) Inventors: JUN HU, NANCHANG (CN); SHIMIN YANG, NANCHANG (CN); XIAODONG MAO, NANCHANG (CN); TAO YANG, NANCHANG (CN)

(21) Appl. No.: 19/403,304

(22) Filed: Nov. 28, 2025

Related U.S. Application Data
(63) Continuation of application No. PCT/CN2025/070418, filed on Jan. 3, 2025.

(30) Foreign Application Priority Data
Nov. 19, 2024 (CN) 202411649452.2

(51) Int. Cl. G01N 21/3586; G01N 21/3563; G06N 20/10

(52) U.S. Cl. CPC G01N 21/3586; G01N 21/3563; G06N 20/10; G01N 2021/3572

(57) ABSTRACT

The present disclosure discloses a method for quantitative detection of adulteration in Angelica sinensis based on terahertz spectroscopy and data fusion, including: (1): taking Angelica pubescens powder as an adulterant; mixing different concentrations of the Angelica pubescens powder into Angelica sinensis powder to prepare samples with varying adulteration levels; (2): placing each sample into a terahertz system, and measuring each sample to obtain terahertz absorption spectrum and time-domain spectral information for the sample; (3): performing feature extraction on the terahertz absorption spectral information of each sample; (4): Utilizing Gramian Angular Difference Field (GADF) to achieve conversion of terahertz time-domain spectra to images, and extracting image feature information; and (5): adopting a feature-level data fusion strategy to integrate feature information from the terahertz absorption spectra and GADF images, and constructing a quantitative adulteration detection model for Angelica sinensis.

### CROSS-REFERENCE TO RELATED APPLICATIONS

The present application is a continuation-application of International (PCT) Patent Application No. PCT/CN2025/070418, filed on Jan. 3, 2025, which claims priority to Chinese Patent Application No. 202411649452.2, filed on Nov. 19, 2024, the entire contents of which are incorporated herein by reference.

### TECHNICAL FIELD

The present disclosure relates to the technical field of chemical detection, and particularly, to a quantitative detection method for adulteration in Angelica sinensis (commonly known as Dang Gui in TCM) based on terahertz spectroscopy and data fusion.

### BACKGROUND

Chinese herbal medicine is an important component of traditional Chinese medicine diagnosis and treatment, as well as a key area in pharmaceutical research. The quality of Chinese herbal medicine directly affects its therapeutic efficacy in clinical applications. Therefore, strict and effective quality control and evaluation of Chinese herbal medicines have always been a critical focus in the medical field. Traditionally, Angelica sinensis (Dang Gui) and Angelica pubescens (Du Huo) both belong to the Umbelliferae family, and their physical characteristics are highly similar. Angelica sinensis is regarded as an effective tonic for treating gynecological diseases and a derived dietary supplement, widely applied to alleviate symptoms such as irregular menstruation and dysmenorrhea in women. Angelica pubescens is typically applied to treat rheumatism and joint pain. Due to its unique medicinal value, Angelica sinensis has significant demand in the international pharmaceutical market, and its price is much higher than that of Angelica pubescens, giving it higher economic value. Unscrupulous merchants often exploit their morphological similarities by mixing Angelica sinensis with Angelica pubescens or substituting one for the other to gain excessive profits. This not only causes a serious crisis of trust in the pharmaceutical industry but also poses unpredictable safety risks and health hazards to patients. Therefore, it is necessary to conduct purity testing of Angelica sinensis to ensure its effectiveness.

Conducting adulteration detection in medicines is an important means to maintain the order of the pharmaceutical market. Techniques commonly adopted for adulteration identification include microscopic techniques, high-performance liquid chromatography, gas chromatography-mass spectrometry, and immunochromatographic assays. However, these techniques are not only time-consuming and labor-intensive but, more importantly, they damage the samples being tested. Consequently, developing a fast and reliable non-destructive technique for adulteration detection has significant practical importance.

Terahertz waves (0.1-10 THz) are a unique segment of electromagnetic radiation located between microwaves and infrared waves, with wavelengths approximately ranging from 3 mm to 30 μm. In recent years, scientific breakthroughs in radiation sources and key equipment have promoted the stable development of terahertz technology, enabling effective utilization of electromagnetic radiation in this special frequency band. The resulting terahertz time-domain spectroscopy (THz-TDS) technology is one of the most remarkable fingerprint spectroscopic techniques and has shown significant advantages in detecting condensed-phase materials. Many weak intermolecular interactions and lattice vibrations can be captured within the terahertz frequency band. Using molecular dynamics, the vibrational mechanisms behind the responses can be effectively parsed, allowing for prediction and judgment of target molecules. Therefore, terahertz spectroscopy technology is widely applied in areas such as agricultural product quality testing and food safety control. However, there is currently no research on using terahertz spectroscopy technology for detecting adulteration in Angelica sinensis.

Data fusion, as an emerging analytical strategy, has demonstrated its unique advantages in the field of spectroscopic applications, showing a growing potential to enhance spectral interpretation capabilities. The evolution patterns of substances under different spectroscopic techniques can vary, meaning that the information captured by different techniques may be complementary. This provides new data support for solving complex problems and further improves the analytical precision for determining substance composition or characteristics. Spectroscopy technology has also shown high application value when fused with other detection methods, such as electronic nose (E-nose), electronic tongue (E-tongue), machine vision (MV), and nuclear magnetic resonance (NMR). However, these fusion strategies involve the intervention of other detection technologies, which directly increases the complexity of experimental design and execution, requires effective collaboration among professionals, and raises detection costs. Therefore, enhancing the relevance of spectral information, and improving data quality and application effectiveness are key issues to overcome the limitations of single-spectroscopy techniques.

### SUMMARY OF THE DISCLOSURE

A method for quantitative detection of adulteration in Angelica sinensis based on terahertz spectroscopy and data fusion, including:
(1) Taking Angelica pubescens powder as an adulterant; mixing different concentrations of the Angelica pubescens powder into Angelica sinensis powder to prepare samples with varying adulteration levels; where an amount of the Angelica pubescens powder added ranges from 0% to 100%.
(2) Placing each sample into a terahertz system, and measuring each sample to obtain terahertz absorption spectrum and time-domain spectral information for the sample.
(3) Preprocessing spectral data by Standard Normal Variate (SNV) transformation combined with Baseline Correction, and then performing feature extraction on the terahertz absorption spectra by Competitive Adaptive Reweighted Sampling (CARS), Iteratively Retaining Informative Variables (IRIV), and Variable Iterative Space Shrinkage Approach (VISSA).
(4) Utilizing Gramian Angular Difference Field (GADF) to encode terahertz time-domain spectral data within 15-20 ps into GADF images:
normalizing one-dimensional data, and then mapping the one-dimensional data to a cosine angle φ in polar coordinates, with time-series points represented by radial distance r, expressed as follows:

$$φ = arccos ( {x}_{i} ) , - 1 \leq {x}_{i} \leq 1 , {x}_{i} ∈ X$$

$$r = \frac{{t}_{i}}{N} , {t}_{i} ∈ N$$

where xᵢ represents a time series, tᵢ represents a timestamp, and N is a parameter to adjust span of the polar coordinates; the GADF is calculated by the following formula:

$$GADF = [ \begin{matrix}cos ( {φ}_{1} - {φ}_{1} ) & cos ( {φ}_{1} - {φ}_{2} ) & … & cos ( {φ}_{1} - {φ}_{n} ) \\ cos ( {φ}_{2} - {φ}_{1} ) & cos ( {φ}_{2} - {φ}_{2} ) & … & cos ( {φ}_{2} - {φ}_{n} ) \\ ⋮ & ⋮ & ⋱ & ⋮ \\ cos ( {φ}_{n} - {φ}_{1} ) & cos ( {φ}_{n} - {φ}_{2} ) & … & cos ( {φ}_{n} - {φ}_{n} )\end{matrix} ] ;$$

and
utilizing Gray-Level Co-occurrence Matrix (GLCM) to read texture features of each GADF image at 0°, 45°, 90°, and 135° successively, calculating Energy, Entropy, Angular Second Moment (ASM), and Correlation of the GADF image, and outputting a mean and standard deviation of the Energy, the Entropy, the ASM, and the Correlation as a feature subset; utilizing Gray-Level Difference Statistics (GLDS) to calculate Mean, Contrast, ASM, and Entropy of the GADF image successively as another feature subset.
(5) Adopting a feature-level data fusion strategy to fuse feature information of the terahertz absorption spectra and the GADF images; and establishing a quantitative detection model based on Support Vector Regression (SVR) algorithm, wherein Kennard-Stone (K-S) algorithm is utilized to divide data into a modeling set and a prediction set in a 3:1 ratio, which serves as input data for the quantitative detection model, with a penalty factor set to 4 and a radial basis function parameter set to 2.5.

In some embodiments, the operation (1) specifically includes:

for each sample, before sample preparation, drying and storing Angelica sinensis and Angelica pubescens in a constant temperature oven at 50° C.; before making pellets, fully grinding a drug that is composed of the Angelica sinensis and Angelica pubescens and crushed by a pulverizer in a mortar to obtain powder, and sieving the powder through a 100-mesh sieve to obtain drug powder; utilizing polyethylene (PE) powder as a binder, mixing the drug powder and the PE powder in a 2:3 ratio in a centrifuge tube, fully homogenizing using a vortex mixer, and then pressing into the pellets, wherein each sample is pressed under 12 MPa pressure for one minute, with a sample thickness of 1.2 mm; wherein the Angelica sinensis powder and the Angelica pubescens powder are taken to prepare samples with different adulteration ratios, with the Angelica pubescens powder as the adulterant; 21 adulteration concentration gradients are provided, where an amount of the Angelica pubescens powder added from 0% to 100% in 5% intervals, with 3 parallel samples set for each concentration gradient; a total number of the samples is 63.

In some embodiments, the operation (2) specifically includes:

fully preheating a terahertz time-domain spectrometer for 30 minutes before experimental testing, and setting each measured spectrum as an average of 1028 scans, with a scanning frequency range set to 0.1-7 THz; after placing each sample into an optical chamber of the terahertz time-domain spectrometer, waiting for 3 minutes before measurement; taking two measurement points for parallel samples of each concentration, with each point measured 10 times repeatedly, collecting 60 spectral lines for each concentration, and obtaining a total of 1260 spectral data points; and measuring absorbance of the samples as analytical data, wherein the absorbance A(ω) of each sample is calculated by the following formula:

$$A ( ω ) = - 10 ln \frac{{A}_{sam} ( ω )}{{A}_{ref} ( ω )} ;$$

where Aₛₐₘ(ω) is an amplitude of a frequency-domain signal of the sample, and A_{ref}(ω) is an amplitude of a reference signal.

### BRIEF DESCRIPTION OF THE DRAWINGS

The above and/or additional aspects and advantages of the present disclosure will become apparent and readily understood from the description of the embodiments in conjunction with the following drawings.

FIG. 1 shows terahertz spectra under different optical parameters: (a) absorption spectra of Angelica sinensis and Angelica pubescens; (b) first derivative spectrum of Angelica pubescens; (c) time-domain spectra of Angelica sinensis and Angelica pubescens.

FIG. 2 shows the GADF image of Angelica sinensis.

FIG. 3 shows the GADF image of Angelica pubescens.

FIG. 4 shows the color difference between adulterated samples of different concentrations and pure Angelica sinensis.

FIG. 5 shows a heatmap of the color difference for adulterated samples of different concentrations.

FIG. 6 shows the wavelength variable screening results based on CARS.

FIG. 7 shows the wavelength variable screening results based on IRIV.

FIG. 8 shows the wavelength variable screening results based on VISSA.

FIG. 9 shows the fitting of data by different models: (a) original spectrum model and (c) IRIV-SVR model.

FIG. 10 shows the fitting of data by different models: (b) CARS-SVR model and (d) VISSA-SVR model.

FIG. 11 shows the fitting of data by different models: (e) CARS-GLCM-GLDS-SVR model and (g) VISSA-GLCM-GLDS-SVR model.

FIG. 12 shows the fitting of data by different models: (f) IRIV-GLCM-GLDS-SVR model and (h) accuracy improvement results of the fusion model.

### DETAILED DESCRIPTION

To make the objectives, features, and advantages of the present disclosure more apparent and easier to understand, the specific implementations of the present disclosure are described in detail below with reference to the accompanying drawings. Several embodiments of the present disclosure are given in the drawings. However, the present disclosure can be implemented in many different forms and is not limited to the embodiments described herein. On the contrary, these embodiments are provided to make the disclosure of the present disclosure more thorough and comprehensive.

Unless otherwise defined, all technical and scientific terms used herein have the same meaning as commonly understood by those skilled in the technical field of the present disclosure. The terminology used in the specification of the present disclosure is for the purpose of describing specific embodiments only and is not intended to limit the invention. The term “and/or” used herein includes any and all combinations of one or more related listed items.

The embodiments of the present disclosure provide a method for quantitative detection of adulteration in Angelica sinensis based on terahertz spectroscopy and data fusion, including the following operations (1) to (5).

Operation (1): Taking Angelica pubescens powder as an adulterant; mixing different concentrations of the Angelica pubescens powder into Angelica sinensis powder to prepare samples with varying adulteration levels; where an amount of the Angelica pubescens powder added ranges from 0% to 100%.

To minimize the influence of residual moisture in the samples on the experimental spectra and to dry the experimental materials without damaging their chemical stability, Angelica sinensis and Angelica pubescens were placed in a constant temperature oven at 50° C. for drying before sample preparation and then stored. Before making pellets, the crushed herbs were poured into a mortar and fully ground, and the ground powder was passed through a 100-mesh sieve to remove large particle impurities. High-density polyethylene powder was used as a binder in the experiment. The herb powder and PE powder were placed in a centrifuge tube in a 2:3 ratio, fully mixed using a vortex mixer, and then pressed into pellets. Each sample was pressed under 12 MPa pressure for one minute, resulting in a pellet thickness of approximately 1.2 mm. The experiment prepared samples with different adulteration ratios by mixing Angelica pubescens powder with Angelica sinensis powder. Using Angelica pubescens powder as the adulterant, a total of 21 adulteration concentration gradients were prepared (amount of Angelica pubescens powder added from 0% to 100%, in 5% intervals). Three parallel samples were set for each concentration gradient, totaling 63 mixed samples (each approximately 200 g).

Operation (2): Placing each sample into a terahertz system, and measuring each sample to obtain terahertz absorption spectrum and time-domain spectral information for the sample.

A TAS7500 terahertz time-domain spectrometer from Advantest, Japan, was used for data collection. All experimental operations were performed in the transmission module. The testing environment was maintained at a temperature of 25° C.+0.5° C. and humidity below 10%, with dry air continuously flowing through the optical test chamber throughout the process. To obtain more accurate spectral data, the instrument was fully preheated for 30 minutes before the experiment, and each measured spectrum was set as the average of 1028 scans. The scanning frequency range was set from 0.1 to 7 THz.

Before measurement, the optical chamber was fully preheated to ensure the chamber temperature was around 25° C.±0.5° C. and the sample compartment air humidity was below 10%. Under stable and dry testing conditions, the air inside the optical chamber was collected as the measurement background. To minimize disturbance to the chamber environment caused by sample changes, each sample was measured after waiting for 3 minutes after being placed in the optical chamber. Two points were measured for each parallel sample of the same concentration, with each point measured 10 times repeatedly. Sixty spectral lines were collected for each concentration group, resulting in a total of 1260 spectral data points. Due to differences in material density, even with the same mass, samples of different concentrations may exhibit different porosities after pressing. Absorbance can effectively reduce the impact of inconsistent sample thickness on the experiment; therefore, the absorbance of the samples was primarily measured as the analytical data. The absorbance A (@) of a sample is calculated by the following formula:

$$A ( ω ) = - 10 ln \frac{{A}_{sam} ( ω )}{{A}_{ref} ( ω )}$$

Where Aₛₐₘ(ω) is the amplitude of the sample's frequency-domain signal, and A_{ref}(ω) is the amplitude of the reference signal.

Operation (3): Performing feature extraction on the terahertz absorption spectral information of each sample.

The operation (3) specifically includes the following.

Since the samples are formed by pressing powders of different substances, the particles exhibit different masses, volumes, shapes, and arrangement characteristics at the micro level. These microscopic features may alter the propagation path of terahertz waves and even cause varying degrees of scattering and absorption as the waves penetrate the sample. Standard Normal Variate (SNV) transformation is commonly used to eliminate differences caused by spectral intensity between samples, and Baseline Correction is used to remove baseline drift in spectral data caused by instrument noise or background interference. SNV combined with Baseline Correction may be used for preprocessing the spectral data.

Irrelevant information in high-dimensional data often introduces noise or interference into the model, potentially increasing model complexity and the risk of overfitting. Therefore, feature selection is a key technique for improving model performance. Competitive Adaptive Reweighted Sampling (CARS) dynamically adjusts feature weights, uses multiple iterations to evaluate feature importance, gradually selects features with higher weights, and finally outputs an optimal variable set. Iteratively Retaining Informative Variables (IRIV) retains both strongly and weakly informative variables in each iteration. Strongly informative bands continue to drive the model until non-informative and interfering variables are completely eliminated from the feature set, finally outputting the optimal variable set through backward elimination. Variable Iterative Space Shrinkage Approach (VISSA) utilizes Weighted Binary Matrix Sampling (WBMS) to optimize the features of the generated variable subspace, and the variable space can be gradually optimized as it continuously shrinks, thereby calculating the feature set with the highest weight. CARS, IRIV, and VISSA may be used for feature extraction of terahertz absorption spectra.

Operation (4): Utilizing Gramian Angular Difference Field (GADF) to achieve conversion of terahertz time-domain spectra to images, and extracting image feature information.

The Gramian Angular Difference Field is an effective method for encoding one-dimensional data with temporal characteristics into two-dimensional images. It calculates the cosine values between spatial vectors and maps these values onto the pixels of a two-dimensional image, resulting in an image that reflects the dynamics and periodic characteristics of the time-series data. The present disclosure uses GADF to perform image encoding on terahertz time-domain spectral data within the 15-20 ps range, which contains a total of 2501 data points. First, the one-dimensional data is normalized and mapped to the cosine angle φ in polar coordinates, while the time-series points are represented by the radial distance r. The expressions are as follows.

$$φ = arccos ( {x}_{i} ) , - 1 \leq {x}_{i} \leq 1 , {x}_{i} ∈ X$$

$$r = \frac{{t}_{i}}{N} , {t}_{i} ∈ N$$

Where xᵢ represents the time series, tᵢ represents the timestamp, and N is a parameter to adjust span of the polar coordinates. The GADF matrix is then calculated by the following formular.

$$GADF = [ \begin{matrix}cos ( {φ}_{1} - {φ}_{1} ) & cos ( {φ}_{1} - {φ}_{2} ) & … & cos ( {φ}_{1} - {φ}_{n} ) \\ cos ( {φ}_{2} - {φ}_{1} ) & cos ( {φ}_{2} - {φ}_{2} ) & … & cos ( {φ}_{2} - {φ}_{n} ) \\ ⋮ & ⋮ & ⋱ & ⋮ \\ cos ( {φ}_{n} - {φ}_{1} ) & cos ( {φ}_{n} - {φ}_{2} ) & … & cos ( {φ}_{n} - {φ}_{n} )\end{matrix} ]$$

Texture is often used to describe the spatial distribution and relationship of pixel grayscale in an image. Processing with GADF achieves the mapping of one-dimensional spectral data onto two-dimensional image pixels, and the image structure can reflect the evolution pattern of the time-series signal. Therefore, grayscale processing algorithms can effectively capture features from GADF images. Gray-Level Co-occurrence Matrix (GLCM) and Gray-Level Difference Statistics (GLDS) can be used to describe the spatial relationship of pixel grayscale values and the differences in grayscale values between pixel pairs, respectively. The present disclosure used GLCM to read the texture features of the GADF image at 0°, 45°, 90°, and 135° angles, calculating the image's Energy, Entropy, Angular Second Moment (ASM), and Correlation. The mean and standard deviation of Energy, Entropy, ASM, and Correlation were output as a feature subset.

Furthermore, GLDS can effectively reveal the closeness of variation between adjacent pixels in a local area by calculating the differences in pixel grayscale values to generate a grayscale difference image. Based on these differences, a grayscale difference histogram is established, and various statistical features of the image are calculated. The present disclosure used GLDS to calculate the image's Mean, Contrast, ASM, and Entropy as a feature subset.

Operation (5): Adopting a feature-level data fusion strategy to integrate feature information from the terahertz absorption spectra and GADF images, and constructing a quantitative adulteration detection model for Angelica sinensis.

Traditional signal processing methods may struggle to fully capture the underlying periodicity and trends in time-domain signals, making it difficult to effectively extract and utilize key variables in the data. Therefore, the present disclosure employs GADF transformation to map spectral information with temporal characteristics into a two-dimensional space, intuitively displaying the differences between different samples through grayscale changes between image pixels. Compared to traditional fusion strategies based on spectra from different optical parameters and time-domain spectra, the use of GADF images demonstrates the application potential of spectral features in different forms of representation, providing a new approach for constructing fusion models.

A colorimeter (CR-10, KONICA MINOLTA, Tokyo, Japan) was used for color difference analysis of samples with different adulteration levels. The present disclosure measured the color of pure Angelica sinensis powder as the standard color. Based on the CIELAB color space theory adopted by the International Commission on Illumination (CIE) in 1976, which is considered the model closest to human color perception, the three-color coordinates L*, a*, and b* were calculated for each adulterated sample. The present disclosure uses the color difference value (dE) to represent the degree of difference between two color samples, calculated by the formula as followed.

$$dE = {[ {( {L}^{*} - {L}_{0}^{*} )}^{2} + {( {a}^{*} - {a}_{0}^{*} )}^{2} + {( {b}^{*} - {b}_{0}^{*} )}^{2} ]}^{1 / 2}$$

Where

$${L}_{0}^{*}$$

represents the lightness of the pure Angelica sinensis powder,

$${a}_{0}^{*}$$

represents the range from green to red for the pure Angelica sinensis powder, and

$${b}_{0}^{*}$$

represents the range from blue to yellow for the pure Angelica sinensis powder.

Support Vector Regression (SVR) is an algorithm derived from Support Vector Machines (SVM). SVR maps input data to a high-dimensional feature space and computes an optimal separating hyperplane in that space, aiming to have as many training samples as possible fall within the margin bands on either side of the plane while maximizing the width of the margin bands. Therefore, the SVR algorithm has significant advantages in improving model generalization ability and handling imbalanced data distribution. The present disclosure used the Kennard-Stone (K-S) algorithm to divide the data into a modeling set and a prediction set in a 3:1 ratio, which served as the input data for the SVR model. The penalty factor c of the model was set to 4, and the radial basis function parameter g was set to 2.5.

The present disclosure evaluated the models by calculating the correlation coefficient (r), Root Mean Square Error (RMSE), Residual Prediction Deviation (RPD), and ΔE (|RMSEP−RMSEC|). High-performance models generally have higher r and RPD values (RPD>2 is typically considered to indicate a model with high reliability suitable for analysis), and lower RMSE and ΔE values.

The experimental results and analysis of the present disclosure are as follows:

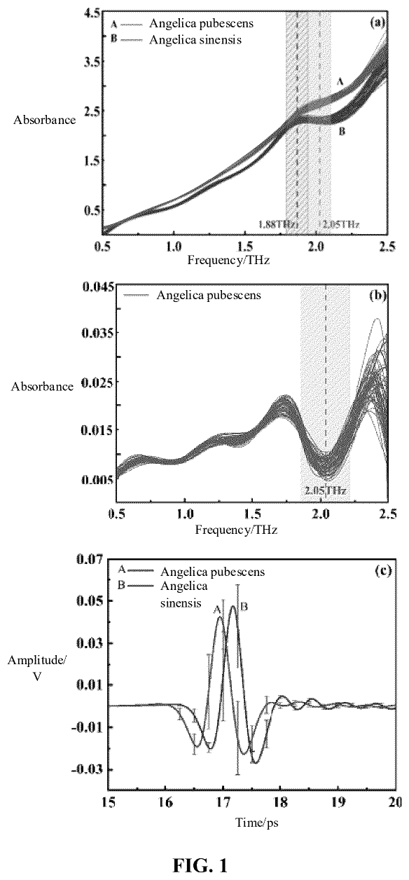

FIG. 1 shows the spectra of each sample under different parameter settings. Specifically, FIG. 1(a) displays the absorption spectra of Angelica sinensis and Angelica pubescens within 0.5-2.5 THz. The absorbance of both increases with the rise in terahertz frequency, and the absorbance of pure Angelica pubescens is consistently higher than that of pure Angelica sinensis. This difference is primarily due to the distinct molecular composition and intermolecular interactions of the two substances. The pure Angelica sinensis sample shows a distinct absorption peak at 1.88 THz, while the pure Angelica pubescens sample exhibits a slight protrusion at 2.05 THz, but without forming a distinct absorption peak shape. The present disclosure applied first-order derivative processing to the spectral data of Angelica pubescens to enhance the discernibility of absorption peaks in the spectrum. The processing result is shown in FIG. 1(b), where a distinct trough appears in the first-derivative image at 2.05 THz. According to the definition of the first derivative, a trough in the derivative data corresponds to a peak in the original spectrum. Therefore, although the absorption peak at 2.05 THz is not obvious in the original spectral image, the presence of this trough indicates that Angelica pubescens has a potential absorption feature at this frequency. Research indicates that ferulic acid is one of the main medicinal components of Angelica sinensis, proven to have antioxidant, antibacterial, and anti-inflammatory effects, holding great potential in the food and pharmaceutical industries. Related researchers, through density functional theory calculations and experiments, have discussed and validated the vibrational modes of ferulic acid in the terahertz band. The results show that ferulic acid produces an absorption peak at 1.90 THz under collective intermolecular vibration modes. Coumarin is one of the main medicinal components of Angelica pubescens, controlling the progression of rheumatoid arthritis by inhibiting the proliferation of synovial fibroblasts. Furthermore, existing research reports confirm that coumarin has an absorption peak excited by intermolecular vibration at 2.06 THz. Therefore, the absorption peaks at 1.88 THz and 2.05 THz are likely excited by the intermolecular vibrations of ferulic acid and coumarin, respectively.

FIG. 1(c) shows the time-domain signals of Angelica sinensis and Angelica pubescens within 15-20 ps. Pure Angelica pubescens responds faster to the terahertz wave, but its amplitude is slightly lower than that of pure Angelica sinensis. This might be because Angelica pubescens has stronger absorption characteristics for terahertz waves in the low-frequency band. The time-domain signal of Angelica sinensis still shows weak oscillations near 20 ps, indicating a certain persistence in its response to terahertz radiation. In contrast, Angelica pubescens shows almost no signal in this time-domain interval, as its response has significantly attenuated within this range.

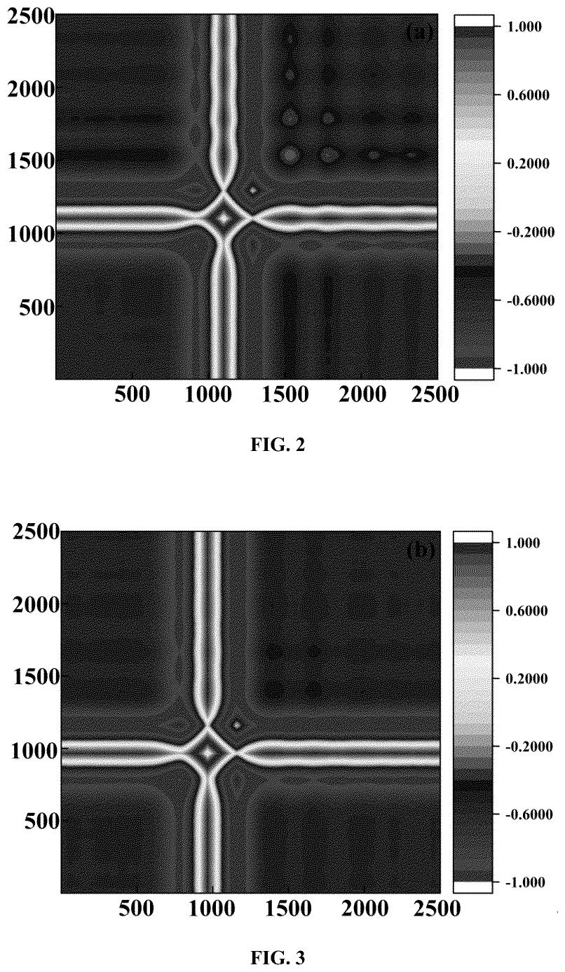

FIGS. 2 and 3 display the GADF images encoded from the time-domain spectral data of the Angelica sinensis and Angelica pubescens samples, respectively. Although the overall structure of the two images is similar, there are significant differences in color intensity and spatial position. Particularly in the first quadrant (upper right), more pixel values in the Angelica sinensis image show stronger tonal intensity, while the Angelica pubescens image shows relatively lower chroma values at the same position. Furthermore, the main feature region of the Angelica sinensis image is centered towards the central part of the image, whereas the main feature region of the Angelica pubescens image is centered towards the lower left corner, with a considerable degree of offset. The essence of the GADF algorithm is to map time-series signals onto image pixels through a specific transformation process, where each pixel contains the characteristic relationships of the signal at different time points. Therefore, changes in color intensity and the spatial position of main features in the GADF image can reflect subtle differences in the sample's time-domain signals. These differences will provide favorable information support for the image algorithm during the feature extraction stage.

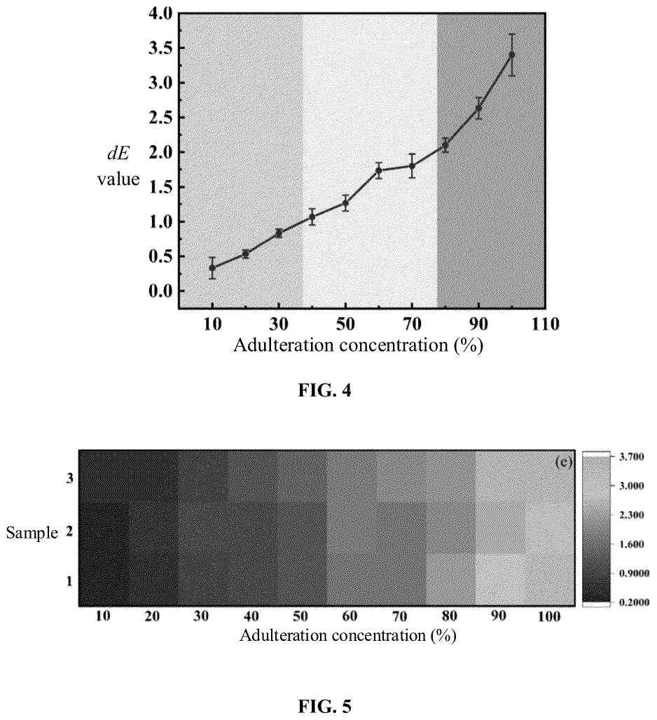

FIG. 4 shows the color difference between adulterated samples of different concentrations and pure Angelica sinensis. As the adulteration amount increases, the color difference value gradually increases. Based on extensive research and application in the field of color science, dE≥2 is generally considered a threshold where the human eye can distinctly perceive a color difference, while when dE≤1, the color difference is difficult to distinguish with the naked eye. Therefore, it is difficult to visually identify whether the medicine is pure Angelica sinensis powder at low adulteration concentrations. At medium adulteration concentrations (1<dE<2), accurate judgment of whether Angelica sinensis is adulterated requires reliance on professionals for distinction. The color difference coordinates show that with the addition of Angelica pubescens powder, the lightness difference (dL) significantly decreases, indicating that the sample darkens overall as the adulteration ratio increases. The red-green difference (da) increases, indicating that the adulterated samples gradually shift towards red. The yellow-blue difference (db) increases, showing that the adulterated samples gradually shift towards yellow.

FIG. 5 is a heatmap of the color difference for adulterated samples of different concentrations. It can be seen that the change in color difference is the result of compound color effects. Distinguishing between low and medium concentration adulterated samples is difficult with the naked eye.

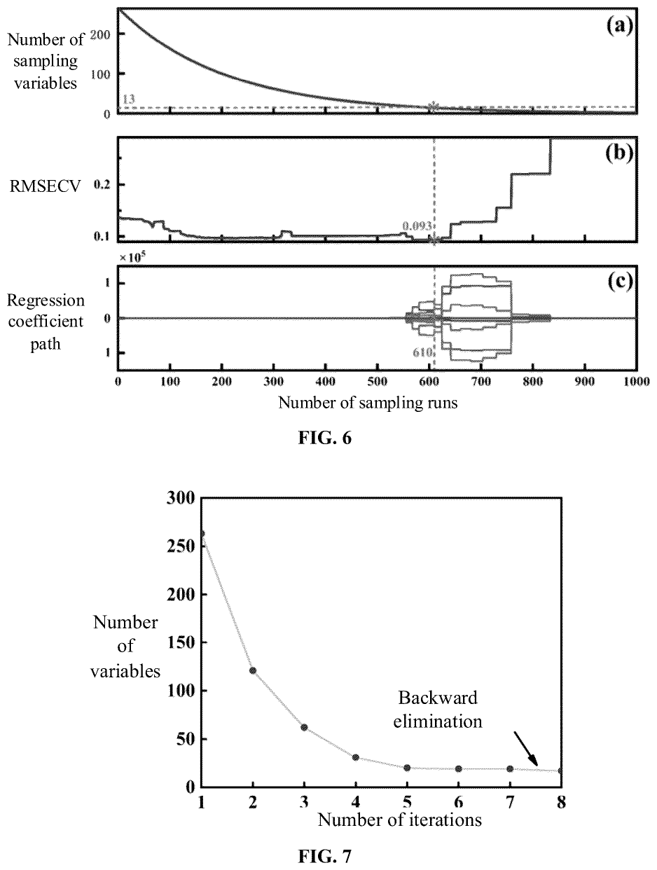

FIG. 6 shows the wavelength variable screening results based on CARS. CARS uses Monte Carlo sampling technology to enhance the robustness of model validation and feature selection. The present disclosure used 1000 Monte Carlo cross-validations to determine the optimal features and principal components. From FIG. 6, it can be concluded that the number of wavelengths decreases sharply after 300 samplings, and the remaining spectral variables undergo further refinement. When the number of samplings reaches 610, the Root Mean Square Error of Cross-Validation (RMSECV) reaches its minimum value of 0.093, indicating that the model's predictive performance in cross-validation is best at this point. After screening, there are 13 feature variables, accounting for 4.94% of the total variables.

The IRIV algorithm uses Exponential Decreasing Function (EDF) and Binary Matrix Sampling (BMS) technologies to optimize spectral feature selection. A total of 500 binary matrix samplings were performed, and 30 EDF runs were used to iteratively optimize feature selection, evaluating model performance in each iteration. Finally, while retaining the optimal number of features, a 5-fold cross-validation method was used to further evaluate the model's generalization ability and performance to determine the optimal feature subset. FIG. 7 shows the relationship between the number of features and the number of iterations. After 6 iterations, the number of features decreased from 263 to 19. Then, an RMSECV calculation was performed on the remaining feature variable combinations using a backward elimination strategy. When the RMSECV is minimized, the backward elimination is completed, finally determining 17 feature variables, accounting for 6.46% of the total variables.

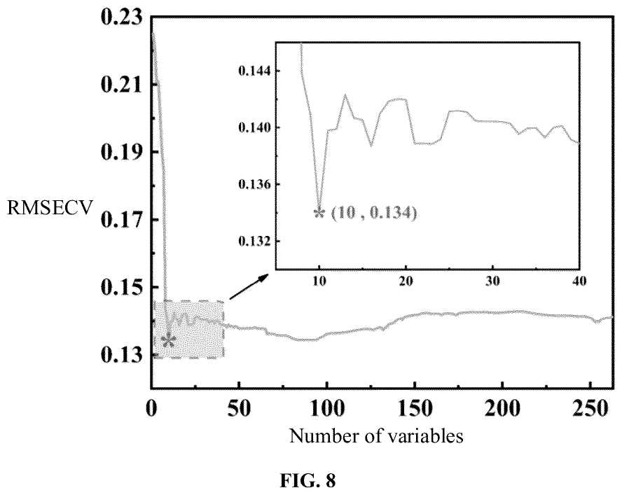

In the VISSA feature selection, the number of variable subsets generated by Weighted Binary Matrix Sampling (WBMS) was set to 1000, the initial sampling weight was 0.5, the proportion of the subset model was 5%, and a 5-fold cross-validation method was used to establish a PLS model. The optimal feature subset was determined based on the minimum RMSECV. FIG. 8 shows the relationship between the number of features and RMSECV. As the number of feature variables increases, the RMSECV value shows a trend of first decreasing sharply, then rising slightly, and finally stabilizing. VISSA finally selected 10 feature variables at the point of minimum RMSECV, where the RMSECV was 0.134. This feature subset accounts for 3.8% of the total variables. Table 1 shows the wavelength screening results of different feature extraction strategies.

TABLE 1
Optimal Feature Variable Results Selected
by CARS, IRIV, and VISSA Methods

| Feature | Total | Optimal | Feature |
|---|---|---|---|
| Extraction | Number of | Number of | Retention |
| Method | Features | Features | Rate |
| CARS | 263 | 13 | 4.94% |
| IRIV | 263 | 17 | 6.46% |
| VISSA | 263 | 10 | 3.8% |

Table 2 shows the modeling effects of the full spectrum and the spectral feature sets. It is worth noting that the RPD of all models is greater than 2, proving that the SVR algorithm has strong adaptability and robustness, maintaining stable performance on datasets of different qualities. The results indicate that feature screening can effectively remove redundant information and noise from the spectral data and improve model accuracy by retaining key information. The regression models constructed from the spectral data processed by CARS, IRIV, and VISSA all perform better than the model built with the original spectral data. Among them, the CARS-SVR model has the best comprehensive performance, with a correlation coefficient (r) reaching 0.9315, an increase of 0.048 compared to the original spectrum model. Meanwhile, compared to IRIV-SVR and VISSA-SVR, the CARS-SVR model has lower RMSE (0.1101) and ΔE (0.0041), indicating a significant advantage in prediction accuracy and error control. At this point, the spectral data input into the model only accounts for 4.94% of the total data.

TABLE 2
Modeling Results of Full Spectrum and Optimal Spectral Variables

| | Feature Extraction | | | | |
|---|---|---|---|---|---|
| Model | Method | r | RMSE | RPD | ΔE |
| SVR | Original Spectrum | 0.8835 | 0.7806 | 2.1387 | 0.1320 |
| | CARS | 0.9315 | 0.1101 | 2.7692 | 0.0041 |
| | IRIV | 0.9237 | 0.1160 | 2.6165 | 0.0122 |
| | VISSA | 0.9186 | 0.1197 | 2.5386 | 0.0100 |

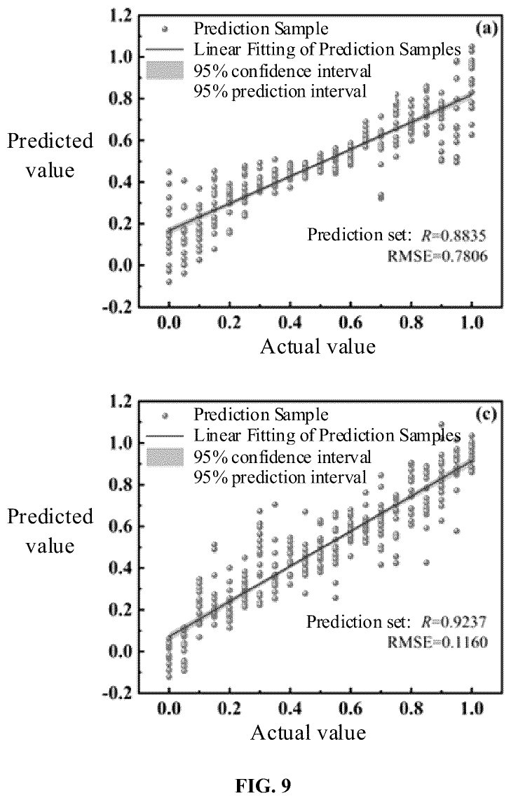

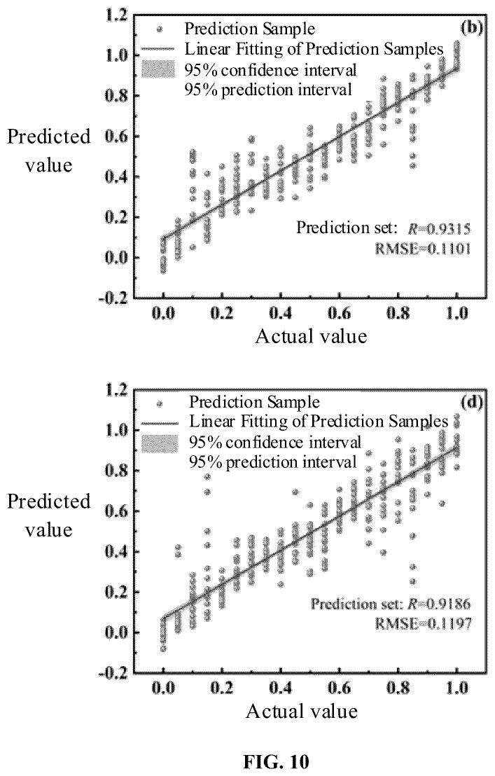

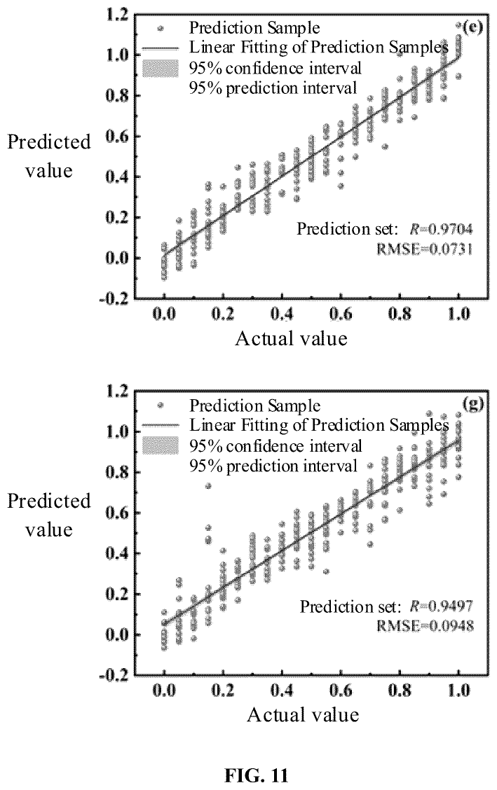

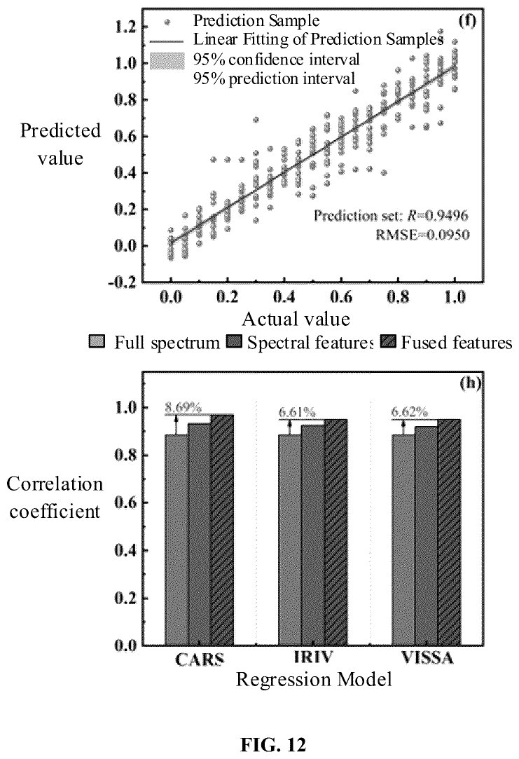

FIGS. 9-12 show the fitting of data by different models. (a) is the model fitting result graph based on the full spectrum data. (b), (c), and (d) show the model fitting result graphs using different feature subsets for modeling. The present disclosure further evaluates the model's fitting effect and predictive ability by calculating the 95% confidence interval and 95% prediction interval for different models. The 95% confidence interval represents the credible interval for the regression line estimate, and the 95% prediction interval represents the prediction range for data points. In this study, whether for full spectrum or feature spectrum modeling, the models all show relatively narrow 95% confidence intervals, and the 95% prediction intervals perform well, further confirming that the SVR model has high accuracy and stability in parameter estimation. For the full spectrum model, the model's residuals are relatively large in the low and high concentration ranges, while they are relatively small in the middle concentration range. This might be due to strong boundary effects in the extreme concentration regions, causing the spectral features in these regions to not fully match the linear relationship assumed by the model, thereby affecting the model's prediction accuracy for extreme values and increasing the residuals. In the models constructed using the feature subsets extracted by CARS, IRIV, and VISSA, the residuals for some concentrations are large, but the overall residuals are more uniform compared to full spectrum modeling. Even after feature extraction, the model might still not fully capture the nonlinear effects at certain concentrations. Samples of specific concentrations might be more sensitive to some subtle but important spectral features, but these effects might be weakened or simplified during data dimensionality reduction, thus leading to larger prediction errors for some concentrations.

Table 3 shows the modeling effect based on the fusion of THz spectrum and GADF image data. The present disclosure used different feature extraction strategies combined with GLCM and GLDS image processing algorithms to construct fusion models based on spectral features and image features. The results show that the dataset fused with image features exhibits significant advantages in the model. Compared to the single feature spectrum model, the correlation of all fusion models is greatly improved, the RMSE values are effectively reduced, and the RPD values are all maintained above 2, indicating the obvious reliability and superiority of the fusion models. It is worth noting that compared to fusing spectral features with either GLCM or GLDS features alone, the models that simultaneously fuse both GLCM and GLDS features perform significantly better than the single-feature fusion models. This indicates that the multi-modal feature fusion strategy can more effectively utilize important information in the data. Through the complementarity of GLCM and GLDS, the texture details of the GADF image are fully preserved, enabling the model to more accurately capture complex nonlinear relationships, thereby enhancing the model's predictive ability. Among them, the CARS-GLCM-GLDS-SVR model has the most outstanding comprehensive performance, with a correlation (r) of 0.9704, and RMSE and RPD of 0.0731 and 4.1429, respectively. Meanwhile, after fusing GLCM and GLDS features, the accuracy of the CARS-SVR model improved by 3.89%, significantly higher than the improvement of the IRIV-SVR and VISSA-SVR models.

TABLE 3
Modeling Results of Data Fusion of
Terahertz Spectrum and GADF Image

| | Feature Fusion | | | | | |
|---|---|---|---|---|---|---|
| Model | Model | r | RMSE | RPD | ΔE | Δr |
| SVR | CARS | 0.9315 | 0.1101 | 2.7692 | 0.0041 | — |
| | CARS-GLCM | 0.9589 | 0.0859 | 3.5311 | 0.0328 | 0.0271 |
| | CARS-GLDS | 0.9676 | 0.0765 | 3.9602 | 0.0103 | 0.0361 |
| | CARS-GLCM- | 0.9704 | 0.0731 | 4.1429 | 0.0442 | 0.0389 |
| | GLDS | | | | | |
| | IRIV | 0.9237 | 0.1160 | 2.6165 | 0.0122 | — |
| | IRIV-GLCM | 0.9467 | 0.0975 | 3.1076 | 0.0467 | 0.0230 |
| | IRIV-GLDS | 0.9469 | 0.0973 | 3.1144 | 0.0291 | 0.0232 |
| | IRIV-GLCM- | 0.9496 | 0.0950 | 3.1887 | 0.0657 | 0.0259 |
| | GLDS | | | | | |
| | VISSA | 0.9186 | 0.1197 | 2.5386 | 0.0100 | — |
| | VISSA-GLCM | 0.9414 | 0.1021 | 2.9702 | 0.0370 | 0.0228 |
| | VISSA-GLDS | 0.9411 | 0.1024 | 2.9575 | 0.0213 | 0.0225 |
| | VISSA- | 0.9497 | 0.0948 | 3.1963 | 0.0488 | 0.0311 |
| | GLCM-GLDS | | | | | |

FIGS. 9(e), (f), and (g) show the model fitting results of different feature extraction strategies simultaneously fused with GLCM and GLDS features. The deep fusion of spectral features and image features effectively reduces the residuals of the regression models, and the 95% prediction intervals of the models are significantly narrowed. Although modeling using spectral feature subsets can effectively improve the correlation, compared with the fitting results of the original spectral data, the 95% prediction intervals of the feature spectrum models are not significantly narrowed, so the predictive ability of the models is still limited. However, after simultaneously fusing GLCM and GLDS features, the 95% prediction intervals of the models become significantly narrower, indicating that the introduced image features provide effective discriminant information for judging the target concentration, allowing the model to more accurately capture the patterns in the data, thereby increasing the confidence of the predicted values and reducing residuals. The IRIV-GLCM-GLDS-SVR and VISSA-GLCM-GLDS-SVR models show significant residuals in some concentration regions, while the CARS-GLCM-GLDS-SVR model has the highest fitting performance.

As shown in (h), the fusion models established based on feature extraction using CARS, IRIV, and VISSA improved the accuracy by 8.69%, 6.61%, and 6.62%, respectively, compared to the original spectral model. The CARS model showed the greatest improvement, with the RMSE of the prediction set decreasing from 0.7806 to 0.0731 and the RPD value increasing from 2.1387 to 4.1429. It is evident that using appropriate feature selection algorithms can effectively improve the model's prediction accuracy and generalization ability for the target variable. In summary, according to the quantitative detection method for Angelica sinensis adulteration based on terahertz spectroscopy and data fusion provided by the present disclosure, using terahertz time-domain spectroscopy (THz-TDS) combined with chemometric methods, taking Angelica sinensis samples adulterated with Angelica pubescens as the research object, and employing a multi-modal feature information fusion method, quantitative analysis of Angelica sinensis adulteration is achieved. By using the Gramian Angular Difference Field to map time-series spectral data onto a two-dimensional plane, creating images by calculating the angles between points in the sequence, and using image processing algorithms to extract image features, intermediate-level fusion with spectral features is performed to construct a regression model, realizing quantitative detection of Angelica sinensis adulteration. The study found that the CARS-GLCM-GLDS-SVR model established using the fusion method of THz spectroscopy and GADF images exhibits excellent performance, with a prediction set correlation coefficient of 0.9704, simultaneously achieving low root mean square error (RMSE=0.0731) and high residual prediction deviation (RPD=4.1429). Compared to the original spectral model, the accuracy is improved by 8.69%, providing an efficient and reliable solution for the detection of Angelica sinensis adulteration.

The embodiments described above only express several implementation modes of the present disclosure. Their descriptions are relatively specific and detailed, but should not be construed as limiting the scope of the present disclosure. It should be noted that for those skilled in the art, without departing from the concept of the present disclosure, several modifications and improvements may be made, all of which fall within the scope of the present disclosure. Therefore, the scope of the present disclosure shall be subject to the appended claims.

1. A method for quantitative detection of adulteration in Angelica sinensis based on terahertz spectroscopy and data fusion, comprising:
(1) taking Angelica pubescens powder as an adulterant; and mixing different concentrations of the Angelica pubescens powder into Angelica sinensis powder to prepare samples with varying adulteration levels; wherein an amount of the Angelica pubescens powder added ranges from 0% to 100%;
(2) placing each sample into a terahertz system, and measuring each sample to obtain a terahertz absorption spectrum and time-domain spectral information for the sample;
(3) preprocessing spectral data by Standard Normal Variate (SNV) transformation combined with Baseline Correction, and then performing feature extraction on the terahertz absorption spectra by Competitive Adaptive Reweighted Sampling (CARS), Iteratively Retaining Informative Variables (IRIV), and Variable Iterative Space Shrinkage Approach (VISSA);
(4) utilizing Gramian Angular Difference Field (GADF) to encode terahertz time-domain spectral data within 15-20 ps into GADF images:
normalizing one-dimensional data, and then mapping the one-dimensional data to a cosine angle φ in polar coordinates, with time-series points represented by radial distance r, expressed as follows:
$$φ = arccos ( {x}_{i} ) , - 1 \leq {x}_{i} \leq 1 , {x}_{i} ∈ X$$
$$r = \frac{{t}_{i}}{N} , {t}_{i} ∈ N$$
where xᵢ represents a time series, tᵢ represents a timestamp, and N is a parameter to adjust span of the polar coordinates; the GADF is calculated by the following formula:
$$GADF = [ \begin{matrix}cos ( {φ}_{1} - {φ}_{1} ) & cos ( {φ}_{1} - {φ}_{2} ) & … & cos ( {φ}_{1} - {φ}_{n} ) \\ cos ( {φ}_{2} - {φ}_{1} ) & cos ( {φ}_{2} - {φ}_{2} ) & … & cos ( {φ}_{2} - {φ}_{n} ) \\ ⋮ & ⋮ & ⋱ & ⋮ \\ cos ( {φ}_{n} - {φ}_{1} ) & cos ( {φ}_{n} - {φ}_{2} ) & … & cos ( {φ}_{n} - {φ}_{n} )\end{matrix} ] ;$$
and
utilizing Gray-Level Co-occurrence Matrix (GLCM) to read texture features of each GADF image at 0°, 45°, 90°, and 135° successively, calculating Energy, Entropy, Angular Second Moment (ASM), and Correlation of the GADF image, and outputting a mean and standard deviation of the Energy, the Entropy, the ASM, and the Correlation as a feature subset; utilizing Gray-Level Difference Statistics (GLDS) to calculate Mean, Contrast, ASM, and Entropy of the GADF image successively as another feature subset; and
(5) adopting a feature-level data fusion strategy to fuse feature information of the terahertz absorption spectra and the GADF images; and establishing a quantitative detection model based on Support Vector Regression (SVR) algorithm, wherein Kennard-Stone (K-S) algorithm is utilized to divide data into a modeling set and a prediction set in a 3:1 ratio, which serves as input data for the quantitative detection model, with a penalty factor set to 4 and a radial basis function parameter set to 2.5.

2. The method according to claim 1, wherein the operation (1) comprises:
for each sample, before sample preparation, drying and storing Angelica sinensis and Angelica pubescens in a constant temperature oven at 50° C.; before making pellets, fully grinding a drug that is composed of the Angelica sinensis and Angelica pubescens and crushed by a pulverizer in a mortar to obtain powder, and sieving the powder through a 100-mesh sieve to obtain drug powder; utilizing polyethylene (PE) powder as a binder, mixing the drug powder and the PE powder in a 2:3 ratio in a centrifuge tube, fully homogenizing using a vortex mixer, and then pressing into the pellets, wherein each sample is pressed under 12 MPa pressure for one minute, with a sample thickness of 1.2 mm;
wherein the Angelica sinensis powder and the Angelica pubescens powder are taken to prepare samples with different adulteration ratios, with the Angelica pubescens powder as the adulterant; 21 adulteration concentration gradients are provided, where an amount of the Angelica pubescens powder added from 0% to 100% in 5% intervals, with 3 parallel samples set for each concentration gradient; a total number of the samples is 63.

3. The method according to claim 2, wherein the (2) comprises:
fully preheating a terahertz time-domain spectrometer for 30 minutes before experimental testing, and setting each measured spectrum as an average of 1028 scans, with a scanning frequency range set to 0.1-7 THz;
after placing each sample into an optical chamber of the terahertz time-domain spectrometer, waiting for 3 minutes before measurement;
taking two measurement points for parallel samples of each concentration, with each point measured 10 times repeatedly, collecting 60 spectral lines for each concentration, and obtaining a total of 1260 spectral data points; and
measuring absorbance of the samples as analytical data, wherein the absorbance A(ω) of each sample is calculated by the following formula:
$$A ( ω ) = - 10 ln \frac{{A}_{sam} ( ω )}{{A}_{ref} ( ω )} ;$$
where Aₛₐₘ(ω) is an amplitude of a frequency-domain signal of the sample, and A_{ref}(ω) is an amplitude of a reference signal.
